(19) United States
(12) Patent Application Publication
(10) Pub. No.: US 2007/0054702 A1
(43) Pub. Date: Mar. 8, 2007

(54) Mobile device enhancement via a vehicular telematics system

(76) Inventors: Daniel S. Rokusek, Long Grove, IL (US); Kranti K. Kambhampati, Palatine, IL (US); James B. Piket, Gilbert, AZ (US); Edward Srenger, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/175,463

(22) Filed: Jul. 6, 2005

(51) Int. Cl. H04B 1/38

(52) U.S. Cl. 455/563

(57) ABSTRACT

An apparatus and method for enhancing a handheld communication device via a telematics system in a vehicle is disclosed. Audio received at the handheld device is transferred to the telematics system in the vehicle. The received audio is then analyzed to determine whether it contains speech, and if so, an audio present signal is generated and the received audio is recorded into a memory coupled to the telematics system. The user can then engage the user interface of the telematics system to replay the recorded audio. Bluetooth protocol is preferably used to establish a channel between the handheld device and the telematics system, which can occur automatically when the two are in proximity. Analysis of the received audio preferably comprises use of a voice detector as part of a speech recognition system otherwise used by the telematics system to assess spoken commands. The memory is preferably overwritten with the latest audio sent from the handheld device to the telematics system, such that engaging the telematics system for playback of the recorded audio will repeat only the last audio sent.

### FIELD OF THE INVENTION

This invention relates to systems and methods for enhancing a handheld communication device such as a cell phone via a telematics system in a vehicle, and in particular allows prior real-time audio from the handheld to be provided to the telematics system for later replay in a manner minimally invasive to telematics system resources.

### BACKGROUND

The field of wireless communications is rapidly changing, and customers continue to demand increased performance and features from their mobile handheld wireless communication devices (e.g., cellular phones, Personal Data Assistants (PDAs), etc.).

At the same time that handheld devices are adding new features and functionality, wireless communications in vehicles are becoming more sophisticated. Thus, many vehicles today contain telematics systems, which generally speaking comprise an in-vehicle communication and positioning system having many useful features to assist drivers with safety and to provide additional communicative conveniences. Although telematics systems generally comprise a transceiver for communicating with systems outside the vehicle, the system can be self-contained in the vehicle and transceiverless.

As can be imagined, there will often be situations in which a handheld communications device is in proximity to a vehicular telematics system. For example, a user with a cell phone when driving his vehicle will usually have the cell phone and the vehicle's telematics system at his disposal. The potential of coupling of these two devices together (the handheld device and the telematics system) provides the opportunity for even improved performance and user convenience as each device has unique functionality which could benefit the other. For example, take the example of a user receiving communications on his cell phone. It might be a nice convenience for the user to use the microphone and speakers (typically the vehicle's radio speakers) of the telematics system to listen to the received communication and to talk in response. In this way, the call on the cell phone is essentially handed off to the telematics system in the vehicle so that the telematics system's resources can be used. The result is improved user convenience and safety, as now the user can participate in the cellular call without the need to hold the cellular handset.

However, such coupling of the handheld device and the telematics system is not without problems. For example, if the handheld device is coupled to the telematics system through a channel for the purpose of routing received audio to the telematics system, there could be circumstances where no audio was received and hence telematics resources could be wasted. For example, in an application in which the user's cell phone is being used to provide audible driving instructions, there would be potentially long periods of time between the announcement of one direction (e.g., “From Smith, turn right to Elm”) and the announcement of the next direction (“From Elm, turn left on Maple”). Despite these long periods, the audio resources for the telematics system (e.g., the vehicle speakers in this example) would be dedicated to the cell phone, and thus could not be used by other devices. This is inefficient, especially when it is realized that the telematics system may largely be broadcasting silence from the cell phone, and that other devices (like the telematics system itself for example) might wish to use the resources during these silent periods for their purposes.

In short, improved solutions are needed for allowing a user to benefit from the coupling of a handheld communication device and a vehicular telematics system. Such solutions are disclosed herein.

### SUMMARY

An apparatus and method for enhancing a handheld communication device via a telematics system in a vehicle is disclosed. In a preferred embodiment, audio received at the handheld device is transferred to the telematics system in the vehicle. The received audio is then analyzed to determine whether it contains speech, and if so, an audio present signal is generated and the received audio is recoded into a memory coupled to the telematics system. The user can then engage the user interface of the telematics system (e.g., through a button) to replay the recorded audio. In a preferred embodiment, the Bluetooth protocol is used to establish a channel between the handheld device and the telematics system, which can occur automatically when the two are in proximity. Analysis of the received audio preferably and conveniently comprises use of a voice detector otherwise used to identify spoken commands to the telematics system, which can be used to generate the audio present signal. In a preferred embodiment, the memory is overwritten with the latest audio sent from the handheld device to the telematics system, such that engaging the telematics system for playback of the audio will repeat only the last audio sent. The system has particular utility where the audio comprises driving directions the user should follow in the vehicle.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a handheld communication device coupled to a telematics system in a vehicle, and various components to allow audio received by the handheld device to be enhanced by the telematics system by utilizing telematics system resources.

### DETAILED DESCRIPTION

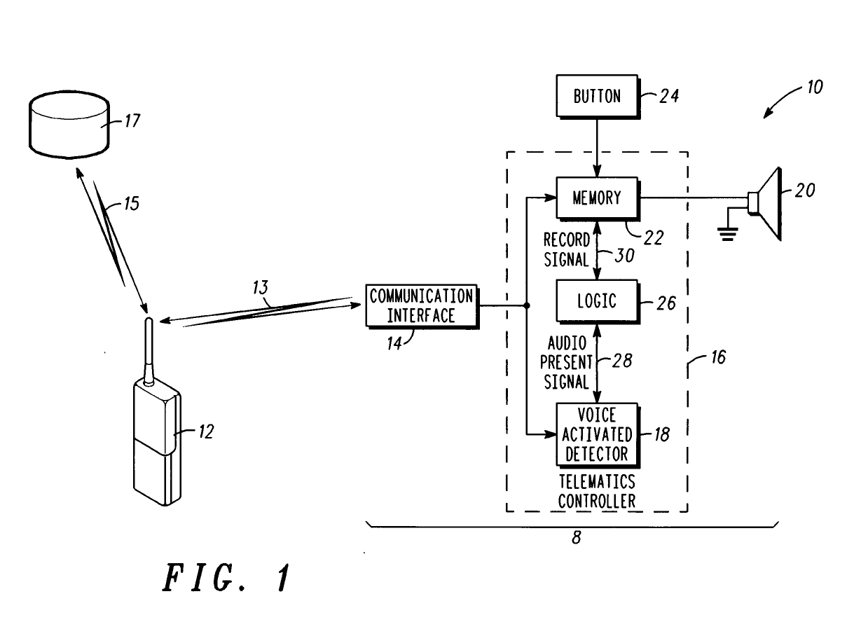

FIG. 1 shows a system 10 comprising a mobile handheld communication device 12 (e.g., a cell phone, a PDA, a laptop computer, etc.) and a vehicular telematics system 8 coupled together through a medium 13. Although the preferred medium 13 comprises a radio frequency (RF) link, other coupling media could be used, such as infrared or a hard wire connection, etc. In a preferred embodiment, the RF media is encoded in accordance with the well-known Bluetooth™ communication standard, and thus both the handheld device 12 and the telematics system 8 comprises a suitable Bluetooth communications interface (e.g., RF interface 14 in the telematics system, which would comprise among other components a transceiver). However, while Bluetooth is preferred in the context of the disclosed system, any other communications protocol could be used to send information between the handheld device 12 and the telematics system 8. The handheld device can comprise any portable handheld device such as a computer or Personal Data Assistant (PDA), but would most often comprise a cellular telephone, which is the example discussed in this disclosure.

The media in useful embodiments of the invention is a two-way communication channel. For example, discussed below is a driving direction feature by which audible directions along a route are sent to or generated by the handheld device 12, and ultimately the audible directions are sent to the telematics system 8. In a typical embodiment, the driving directions would be determined by a software algorithm on the handheld device 12 and the audible driving directions are created by this device and sent to the telematics system 8. Should the handheld device 12 not have GPS functionality, GPS coordinates could be provided to the handheld device 12 from the telematics system 8 over the two-way media link 13 in accordance with the Bluetooth protocol.

As shown, the telematics system 8 comprises a communications interface 14 (discussed briefly above), a telematics controller 16, and a speaker 20. While shown as a single speaker 20, one skilled will understand that the speaker actually represents what would likely in a real commercial embodiment comprise a plurality of speakers (i.e., the vehicle's radio speakers), although a dedicated telematics speaker could be used as well. The telematics system 8 would in a preferred embodiment be mounted or housed within a vehicle, and hence would be portable but capable of wireless connection to other useful systems as is well known. Moreover, a telematics system 8 having the components described herein could comprise integrated components or could comprise a combination of otherwise separate components.

As will be seen below, one aspect of the telematics system 8 will be to receive audio from the handheld device 12 and to play at least portions of that audio through the speaker 20. Hence, the disclosure of the telematics system 8 focuses on description of these components. It should however be realized that an actual telematics system 8 would comprise or couple to other systems not shown for clarity (such as a GPS module, a vehicle interface bus, etc.), such as are disclosed in the above-incorporated reference. To allow the telematics system 8 to play the audio received by the handheld device 12 requires the two to “handshake,” but implementing such mutual recognition is easily accomplished, particularly with use of the Bluetooth standard. Accordingly, the details concerning the coupling of the handheld device 12 and the telematics system 8, and the manner in which the handheld's audio is sent to the telematics system 8, is not further discussed.

One embodiment of the invention uses the voice activity detector (VAD) 18 of the telematics system 8. Normally in a telematics system, the VAD 18 is used to detect the onset and termination of a user's voice to allow the user to input commands to the telematics system 8 without the need and distraction of pressing buttons, etc. For example, in a traditional telematics system 8, a speech recognition system in conjunction with the VAD 18 might be used to act on the audible command for “movie show times,” at which point the telematics system would access a proper database to provide the information sought. The VAD 18 is also sometimes used in a telematics system as a component used in echo cancellation, which should be understood as another embodiment of interpreting spoken commands to the telematics system.

In any event, here the VAD 18 is employed to determine whether a speech signal is being provided to the handheld device 12 previously coupled to the telematics controller 16. Thus, by conveniently using the VAD 18 otherwise provided in the telematics system 8 for another purpose (recognition of user input), it can be determined whether a speech signal is truly present on the channel through which the handheld device 8 and the telematics system 8 are coupled. Of course, use of the VAD 18 in this manner would require some modification. For example, typically the input to the VAD 18 would ultimately be a microphone input to the telematics system 8 (not shown) to pick up a user's speech input. By contrast, in useful embodiments of the invention, the input to the VAD 18 would ultimately comprise the output of the communications interface 14 which contains the speech signal being streamed from the handheld device 12 to the telematics controller 16.

In any event, the VAD 18 assesses the streaming audio of the coupled handheld device 12 and analyzes that stream for human speech in real time. When the VAD 18 determines that speech is present as opposed to other audible signals (e.g., noise), it asserts an Audio Present signal 28. This signal is input to logic 26 in the telematics controller 16 which operates in accordance with the functional aspects as described herein. Such logic, as is well known, can be implemented via software, hardware, or combinations of both.

In a preferred embodiment, logic 26, upon receipt of the Audio Present signal 28, issues a Record signal 30 to a memory 22. Memory 22 could comprise memory preexisting in the telematics system 8, or could comprise additional memory provided specifically for the implementation of the invention. While memory 22 would preferably be semiconductor based (i.e., formed of integrated circuitry), it could also comprise magnetic or optical disk memory for example. In any event, because memory 22 is preferably over-writable for reasons that will become clear later, memory such as Electrically-Erasable Programmable Read Only Memory (EEPROM, or Flash EPROM) is most preferably used.

Once the Record signal 30 is received, the memory 22 starts recording the streamed speech audio sent from the handheld device 12 to the telematics system 8. Recording of the streamed audio would then logically stop when the VAD 18 ceases to discern human speech. This allows the user to replay the streamed audio through the telematics system (e.g., through the car speakers 20 upon pressing button 24), and thus provides a significant advantage in an efficient manner. Take for example the application discussed in the Background in which the user's cell phone receives audible driving directions. It may be the case that the handheld device 12 originally receiving the audio may not be capable of recording the directions it receives, or even if it did it may be cumbersome for the user to replay such directions on the handheld device. By contrast, when the audio is recorded by the telematics system 8, playback of the recorded audio is much simpler and benefits from the ergonomic and safety features inherent to the telematics system 8.

In a preferred embodiment, replay of the audio recorded in memory 22 can be effectuated by the user upon activation of a switch or button 24. Such a button can be that typically used in a vehicle-based telematics system such as a “push-to-talk” button or an “On Star”™ button. Alternatively, replay of the recorded audio in memory can occur through activation of other types of switches, through access to a menu item on a telematics display, by speech recognition, through a button on the radio, or by any other input means used or useable with a telematics system.

The memory 22 can store the received audio in any number of ways. In one preferred embodiment, the memory 22 comprises a one-event buffer that stores only the last audio transferred from the handheld device 12 to the telematics system 8. Thereafter, should another transmission occur, that latest transmission would then be stored in the memory 22, while the first transmission would be overwritten. This preferred one-event-buffer feature has particular utility in the above-mentioned application involving a cell phone providing driving directions to a user.

For example, suppose the handheld device 12 provides audible driving directions to the user. Such directions would be generated in conjunction with a mapping program, which could either be resident within the memory of the phone 12 (not shown), or a server-based application resident on a server 17 and sent to the phone via RF link 15 (e.g., using ViaMoto™). As noted above, such a feature would provide an audible instruction at discrete times, with potential long periods of silence between sequential directions. Accordingly, there is no need for the handheld device 12 to tie up the audio resources of telematics system 8. Thus, in conjunction with an embodiment, the VAD 18 in the telematics system 8 monitors the channel established with the handheld device 12, and issues an Audio Present signal 28 when human speech is detected. (Although the directions might be issued by a computerized voice and opposed to an actual or recorded human voice, the VAD 18 would still be able to discern such speech from background noises).

Upon receipt of the Audio Present signal 28, logic 26 activates memory 22 to record the received audio. Thus, a first direction might be recorded (e.g., “From Smith, turn right to Elm”). With this first direction conveniently stored in the telematics system 8, the user can conveniently use the interface of the telematics system (e.g., button 24) to retrieve this stored message. Without this benefit, the user might not be able to remind himself of the first direction, which he might have missed earlier because of distraction, because inaudible on the handheld device given the noise in the vehicle, etc. Additionally, and as noted earlier, the handheld device may simply be unable to reiterate an already-announced direction, or might require a cumbersome procedure to do so, and thus use of the telematics system 8 to capture the direction is most beneficial. Moreover, although the VAD 18 of the telematics system 8 monitors the audio of the handheld device 12 to which it is coupled, there is no need to dedicate any audio resources (such as the speaker 20) to the handheld device 12 for the entire period that the two are coupled. Instead, such resources need only be captured when the audio stored in memory 22 is requested for playback (e.g., via button 24). Thus, through use of the disclosed technique, the audio resources of the telematics system 8 can be reserved for and used by other devices to which the telematics system might be coupled, or reserved for the telematics system 8 itself.

When the next direction is provided to the handheld device 12, (e.g., “From Elm, turn left on Maple”), the process again continues, but this time storage of this direction overwrites the first direction, such that when the user queries the memory (e.g., via button 24) only this last direction is broadcast through the speakers 20 of the telematics system 8. Such a one-event buffer is preferable for user simplicity: i.e., it is preferred that the telematics user interface (button 24) provide a simple quick means for allowing the user to remind himself of a last important piece of information. In the driving direction example discussed herein, this makes sense as previous directions should no longer be of sufficient interest or could confuse a user. Having said this, it should be noted that the memory 22 could store a plurality of captured audio messages, in which case preferably simple interface techniques would be used to allow the user to select the appropriate stored audio for play back, or scroll through a set of recorded directions (e.g., one press of button 24 for the last message, two presses for the next-to-last message, etc.).

Through use of the disclosed technique, the problem of a handheld device 12 tying up telematics resources without justification is mitigated, as such resources need not be reserved until needed. As such, and as an extension of this concept, the telematics controller 16 can be used to arbitrate between a plurality of devices 12 that might compete for its resources. For example, suppose a user's cell phone, PDA, and notebook computer in the user's vehicle (not shown) might compete for the telematics system's audio resources. Logic 26 in such a circumstance can be used to control the memory 22 accordingly so as to arbitrate between the various calls to the telematics system's resources. For example, logic 26 might express a preference for one device to record its audio over another, or to store the audio from both, with one given priority over another during playback.

Although this disclosure has focused on the example of using the telematics system 8 to record and allow play back of driving directions, it should be recognized that this comprises only an example. Instead, the telematics system 8, vis-à-vis the handheld device 12, can be thought of as a recorder to record any speech data received by the phone. Such audio would potentially include even a normal phone call that a user might wish to listen to later (e.g., a call from a spouse reminding to pick up a gallon of milk, a call from one's boss, etc.). Additionally, the disclosed technique can also be used in the transmission and playback of data at the telematics unit, instead of audio, in which case a VAD would not be necessary.

Although it is preferred for simplicity that the telematics system 8 be capable (via VAD 18) of making its own decision to record audio independent of the device 12 coupled to it, in other embodiments, the device 12 can also be involved in the process. For example, the device 12 can be enabled to send an instruction to the control logic 26 of the telematics system 8 to start the disclosed process, i.e., to start monitoring the audio channel for human speech via VAD 18 in conjunction with a speech recognition system and to record as appropriate. In this way, the device 12 can selectively help the telematics system 8 to know what audio to monitor and record. Such an improvement might be useful where, e.g., a user is receiving movie listings, but doesn't need to record an introductory message. Thus assume the movie listing announcement states the following two phrases: “Welcome to Movie source, your source for movie information. Star Wars is playing at Garret Theater at 1:30 pm on screen 6.” Knowing that the first “welcome” phrase is not valuable to record, the handheld device might issue a monitor/record instruction between the first and second phrases, so that only the latter phrase is recorded for the user's benefit. This instruction could be automatic, or could be dictated by the user. For example, the user could press an appropriate button on the device 12 to issue the monitor/record instruction to the telematics system 8 at the appropriate time. In the case where the device 12 issues an instruction, it may not be necessary for the VAD 18 to operate in the telematics unit, as the device 12 presumably would have already decided that the audio being transmitted from the device 12 to the telematics system 8 is voice and should be recorded.

It should be understood that the inventive concepts disclosed herein are capable of many modifications. To the extent such modifications fall within the scope of the appended claims and their equivalents, they are intended to be covered by this patent.

What is claimed is:

1. A method of enhancing a handheld communication device via a telematics system in a vehicle, comprising:
receiving or generating audio at the handheld device;
transferring the audio from the handheld device to the telematics system in the vehicle;
analyzing the audio at the telematics system to recognize the receiving audio as speech;
if the audio is recognized as speech, recording the audio into a memory coupled to the telematics system; and
allowing the user to play the recorded audio from the memory by engaging a user interface of the telematics system.

2. The method of claim 1, wherein the audio is transferred to the telematics system using a Bluetooth format.

3. The method of claim 1, wherein analyzing the audio comprises use of a voice detector otherwise used to detect the presence of spoken commands to the telematics system.

4. The method of claim 1, wherein engaging a user interface comprises pressing a button.

5. The method of claim 1, wherein if the audio is recognized as speech, issuing a record signal to the memory to record the audio.

6. The method of claim 1, wherein the handheld device comprises a cellular phone.

7. The method of claim 1, further comprising as a first step in the method automated recognition between the handheld device and the telematics system so as to establish a channel between the handheld device and the telematics system.

8. The method of claim 1, wherein the audio comprises directions the user should follow in the vehicle.

9. A method of coupling the audio of a handheld communication device to a telematics system in a vehicle, comprising:
receiving or generating audio at the handheld device;
transferring the audio from the handheld device to the telematics system in the vehicle via a channel;
issuing a command for the telematics system to record the audio into a memory coupled to the telematics system; and
allowing the user to play the recorded audio from the memory by engaging a user interface of the telematics system.

10. The method of claim 9, wherein the audio is transferred to the telematics system using a Bluetooth format.

11. The method of claim 9, wherein issuing a command comprises the telematics system analyzing the audio using a voice detector otherwise used to detect the presence of spoken commands to the telematics system.

12. The method of claim 9, wherein the command is issued in response to an instruction transferred from the handheld device to the telematics system.

13. The method of claim 9, wherein engaging a user interface comprises pressing a button.

14. The method of claim 9, further comprising as a first step in the method automated recognition between the handheld device and the telematics system so as to establish the channel between the handheld device and the telematics system.

15. The method of claim 9, wherein the audio comprises directions the user should follow in the vehicle.

16. A method of enhancing a handheld communication device via a telematics system in a vehicle, comprising:
receiving or generating first audio at the handheld device;
transferring the first audio from the handheld device to the telematics system in the vehicle;
recording the first audio into a memory coupled to the telematics system;
allowing the user to play the recorded first audio from the memory by activating a user interface of the telematics system;
receiving or generating second audio at the handheld device after the first audio;
transferring the second audio from the handheld device to the telematics system;
recording the second audio into the memory so as to overwrite the recorded first audio; and
allowing the user to play the recorded second audio from the memory by activating the user interface of the telematics system.

17. The method of claim 16, wherein the first audio comprises a first instruction for the user, and wherein the second audio comprises a next instruction for the user.

18. The method of claim 17, wherein the instructions comprise directions the user should follow in the vehicle.

19. The method of claim 16, wherein the first and second audio are transferred to the telematics system using a Bluetooth format.

20. The method of claim 16, further comprising as a first step in the method automated recognition between the handheld device and the telematics system so as to establish a channel between the handheld device and the telematics system.
